(19) United States
(12) Patent Application Publication
(10) Pub. No.: US 2006/0059710 A1
(43) Pub. Date: Mar. 23, 2006

(54) Drying machine

(75) Inventor: Jin Doo Kim, Suwon-City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/127,074

(22) Filed: May 12, 2005

(30) Foreign Application Priority Data
Sep. 20, 2004 (KR) 2004-75194

(51) Int. Cl. F26B 19/00; F26B 25/06

(52) U.S. Cl. 34/603; 34/201

(57) ABSTRACT

A drying machine, in which a hinge bracket is simply and rapidly fixed to the rear surface of a front panel. A pre-assembly unit for firmly fixing the hinge bracket to the front panel is formed on the hinge bracket and the front panel. The pre-assembly unit includes a plurality of fixing holes and a positioning hole formed through the hinge bracket, and a plurality of fixing protrusions and a positioning protrusion protruded from the front panel. The fixing protrusions are caught by the fixing holes and the positioning protrusion is fitted into the positioning hole. In this manner, the hinge bracket is fixed to a designated position on the front panel. Under this state, screw holes formed through the hinge member, the front panel, and the hinge bracket coincide with each other, thereby allowing the hinge member to be screw-connected to the hinge bracket.

### CROSS-REFERENCE TO RELATED APPLICATION

This application claims priority from Korean Patent Application No. 2004-75194, filed Sep. 20, 2004, in the Korean Intellectual Property Office, the disclosure of which is incorporated herein by reference.

### BACKGROUND OF THE INVENTION

1. Field of the Invention

The present invention relates to a drying machine and, more particularly, to a drying machine in which a hinge bracket for installing a hinge member on a front panel is simply and rapidly fixed to the rear surface of the front panel.

2. Description of the Related Art

Generally, in a drying machine or a washing machine, a drum is rotated alternately in clockwise and counterclockwise directions, thereby drying or washing laundry. Each of the drying and washing machines comprises a front panel having an opening formed therethrough, and a door for opening and closing the opening of the front panel. Laundry is put into or taken out of the drying or washing machine through the opening of the front panel under the condition that the door is opened.

A hinge member for rotatably installing the door on the front panel is installed at one side of the front panel, and a latch assembly for locking or unlocking the door to or from the front panel is installed in the other side of the front panel.

The hinge member is attached to the front surface of the front panel by a hinge bracket screw-connected to the rear surface of the front panel. Since the conventional drying or washing machine does not have a structure for pre-assembling the hinge bracket to the front panel before the hinge bracket is screw-connected to the front panel, a worker aligns screw holes formed through the hinge bracket to coincide with screw holes formed through the front panel by manual manipulation, and then connects the screw holes. Accordingly, the conventional drying or washing machine is disadvantageous in that the assembly process of the hinge bracket is complicated and the assembly time of the hinge bracket is lengthened.

Korean Patent Laid-open Publication No. 10-2004-0011218 discloses a drying machine having a structure such that a hinge member is directly screw-connected to a front panel without using a hinge bracket.

That is, since the above drying machine comprises positioning protrusions formed on the hinge member and positioning holes formed through the front panel, each of the positioning protrusions of the hinge member is inserted into the corresponding one of the positioning holes of the front panel before the hinge member is screw-connected to the front panel, thereby pre-assembling the hinge member to the front panel.

However, since the above drying machine, in which the hinge member is directly screw-connected to the front panel having a thin plate shape, has a low bonding force between the hinge member and the front panel, the drying machine is disadvantageous in that the screws are loosened by the frequent opening operation of a door or the vibration generated due to the operation of the drying machine. Further, the drying machine is disadvantageous in that the hinge member cannot be selectively installed at one side of both sides of the front panel according to circumstances, in which the drying machine is installed.

That is, when a user wants to change the position of the hinge member from the right side of the front panel to the left side of the front panel so that the door is opened centering on the left side of the front panel according to circumstances, in which a drying or washing machine is installed, or user's convenience, the hinge member, which was installed at the right side of the front panel, must be separated, and then installed again at the left side of the front panel. Since the hinge member or the hinge bracket of the conventional drying or washing machine is connected to only one side of the front panel, the location of the hinge member or the hinge bracket cannot be changed according to circumstances, in which the drying or washing machine is installed, or user's convenience.

### SUMMARY OF THE INVENTION

Therefore, an aspect of the present invention is to provide a drying machine, in which a hinge bracket for connecting a hinge member to the front surface of a front panel is simply and rapidly fixed to a designated position of the rear surface of the front panel.

Another aspect of the present invention is to provide a drying machine, in which a location of a hinge member on a front panel can be changed by installing hinge brackets on both sides, i.e., right and left sides of the rear surface of the front panel.

In accordance with one aspect, the present invention provides a drying machine comprising: a door; a front panel, on which the door is installed; a hinge member for hinging the door to the front panel; and a hinge bracket for connecting the hinge member to the front panel, wherein a pre-assembly unit for positioning and fixing the hinge bracket on and to the front panel is formed on the hinge bracket and the front panel.

The pre-assembly unit may include a pair of first fixing holes formed through the hinge bracket, and a pair of first fixing protrusions protruded from the rear surface of the front panel and caught by the first fixing holes.

Through holes may be respectively formed through the central area of the hinge bracket and the front panel so that a projecting part protruding from the rear surface of the hinge member is inserted into the through holes; and the first fixing holes, each of which has a designated size, may be extended from both sides of the through hole of the hinge bracket.

Each of the first fixing protrusions may include a vertical portion protruding from the rear surface of the front panel and having a length corresponding to the thickness of the hinge bracket, and a horizontal portion extended horizontally from the vertical portion and inserted into the corresponding one of the first fixing holes.

The pre-assembly unit may include a second fixing hole formed through the hinge bracket, and a second fixing protrusion protruding from the rear surface of the front panel and caught by the second fixing hole.

The second fixing protrusion may include a vertical portion protruding from the rear surface of the front panel and extended to have a length corresponding to the thickness of the hinge bracket, and a horizontal portion extended horizontally from the vertical portion to have a length smaller than that of the second fixing hole and inserted into the second fixing hole.

The pre-assembly unit may include a positioning hole formed through the hinge bracket, and a positioning protrusion protruding from the rear surface of the front panel and fitted into the positioning hole.

The pre-assembly unit may include a projecting part protruding from one side end of the hinge bracket and caught by the side surface of a protrusion, protruding from the edge of an opening formed through the central portion of the front panel, to be fixed to a designated position.

In accordance with another aspect, the present invention provides a drying machine comprising: a front panel having an opening formed through the central portion thereof; a door installed on the front panel for opening and closing the opening; a hinge member for hinging the door to the front panel; a pair of hinge brackets for selectively connecting the hinge member to one of both sides of the opening of the front panel; and a pre-assembly unit formed on the rear surfaces of the hinge bracket and the front panel for positioning and fixing the hinge bracket on and to the front panel.

The pre-assembly unit may include at least one fixing hole formed through the hinge bracket, at least one fixing protrusion protruded from the rear surface of the front panel and caught by the fixing hole, a positioning hole formed through the hinge bracket, and a positioning protrusion protruding from the rear surface of the front panel and fitted into the positioning hole.

The fixing hole may have a size greater than that of the fixing protrusion; and the fixing protrusion may include a vertical portion vertically protruding from the rear surface of the front panel and having a length corresponding to the thickness of the hinge bracket, and a horizontal portion horizontally extended from the vertical portion, so that the vertical portion passes through the fixing hole and the horizontal portion is inserted into the fixing hole, and simultaneously the positioning hole is fitted to the positioning protrusion, thereby pre-assembling the hinge bracket with the front panel without movement.

The pre-assembly unit may further include a projecting part protruding from one side end of the hinge bracket and caught by the side surface of a protrusion, protruding from the edge of an opening formed through the central portion of the front panel, to be fixed to a designated position.

### BRIEF DESCRIPTION OF THE DRAWINGS

These and/or other aspects and advantages of the invention will become apparent and more readily appreciated from the following description of the exemplary embodiments, taken in conjunction with the accompanying drawings in which:

FIG. 1 is a perspective view of a drying machine in accordance with an exemplary embodiment of the present invention;

FIG. 2 is a rear perspective view of a front panel having a hinge bracket attached to the rear surface thereof;

FIG. 3 is a perspective view of a portion of FIG. 2, illustrating the state in which the hinge bracket and a hinge member are separated from the front panel;

FIG. 4 is a perspective view of the portion of FIG. 2, illustrating the state just before the hinge bracket is pre-assembled with the rear surface of the front panel; and

FIG. 5 is a perspective view of the portion of FIG. 2, illustrating the state in which the hinge member is fixed to the hinge bracket after the pre-assembling of the hinge bracket with the rear surface of the front panel is completed.

### DETAILED DESCRIPTION OF THE ILLUSTRATIVE NON-LIMITING EMBODIMENTS

Reference will now be made in detail to exemplary embodiments of the present invention, wherein like reference numerals refer to like elements throughout. The exemplary embodiments are described below to explain the present invention by referring to the annexed drawings. The described exemplary embodiments are intended to assist the understanding of the invention and are not intended to limit the scope of the invention in any way.

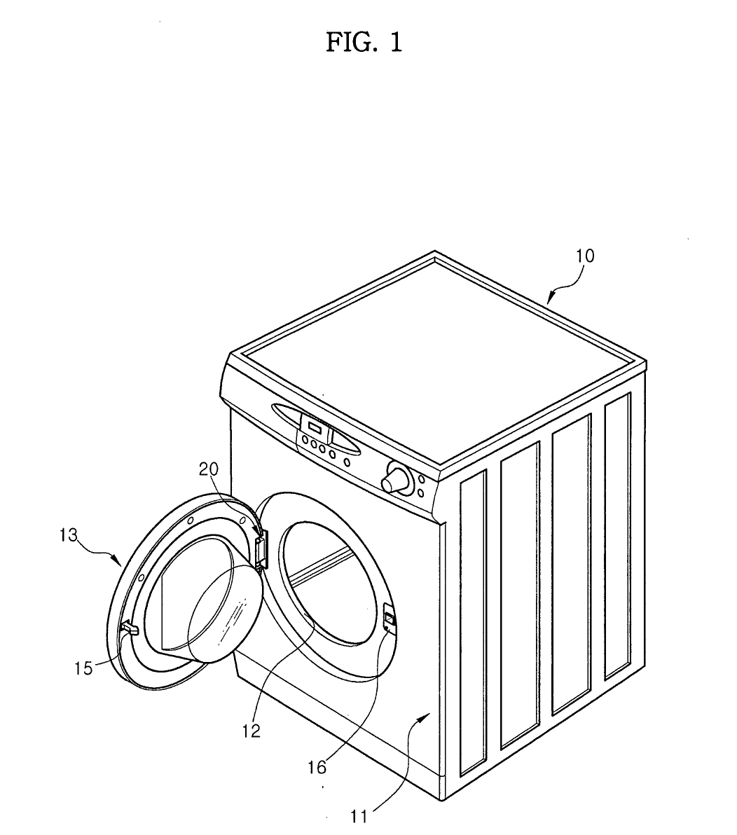

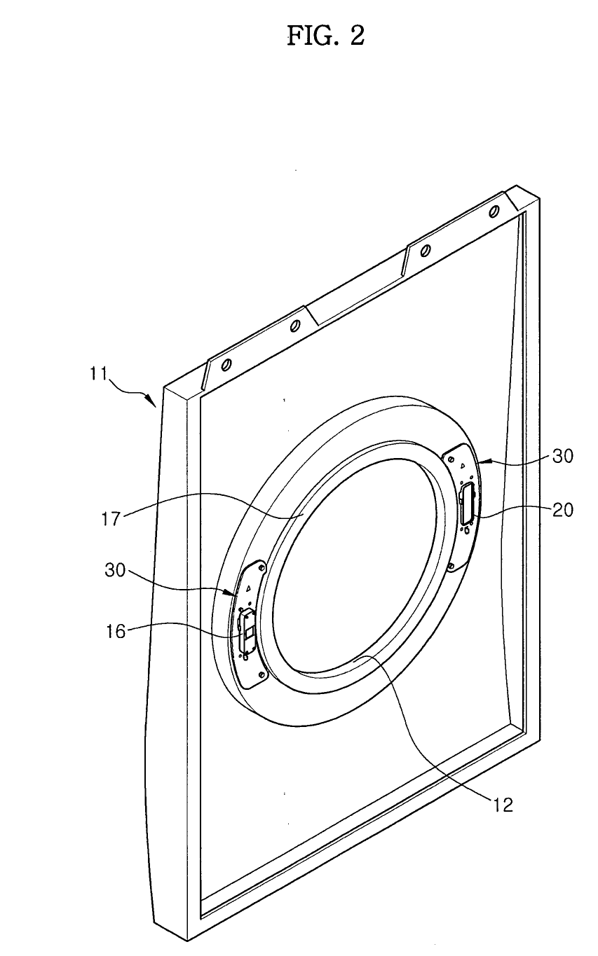

FIG. 1 is a perspective view of a drying machine in accordance with an exemplary embodiment of the present invention, and FIG. 2 is a rear perspective view of a front panel having a hinge bracket attached to the rear surface thereof.

As shown in FIG. 1, a drying machine according to an exemplary embodiment of the present invention comprises a cabinet 10 having the opened front surface thereof, a front panel 11 installed on the opened front surface of the cabinet 10, and a door 13 for opening and closing a circular-shaped opening 12 formed through the central area of the front panel 11.

The door 13 is hinged to the front panel 11 by a hinge member 20 formed at one side of the opening 12, thereby being rotatably installed on the front panel 11. A hook 15 is protruded from one side of the rear surface of the door 15, opposite to the hinge member 15, toward the front panel 11.

A latch assembly 16 is installed in the other side of the opening 12 of the front panel 11 opposite to the hinge member 20, and serves to lock or unlock the hook 15 formed on the door 13, thereby allowing the door 13 to open and close the opening 12 formed through the front panel 11.

As shown in FIG. 2, in order to firmly fix the hinge member 20 to the front panel 11, hinge brackets 30 are installed on the rear surface of the front panel 11. A pair of the hinge brackets 30 are installed at both sides of the opening 12 on the rear surface of the front panel 11 so that the hinge members 20 are respectively installed at both sides of the opening 12 on the front surface of the front panel 11.

A disk-shaped protrusion 17 protruding from the rear surface of the front panel 11 is formed along the edge of the opening 12 of the front panel 11, and the hinge brackets 30 installed at both sides of the opening 12 are positioned close to the protrusion 17.

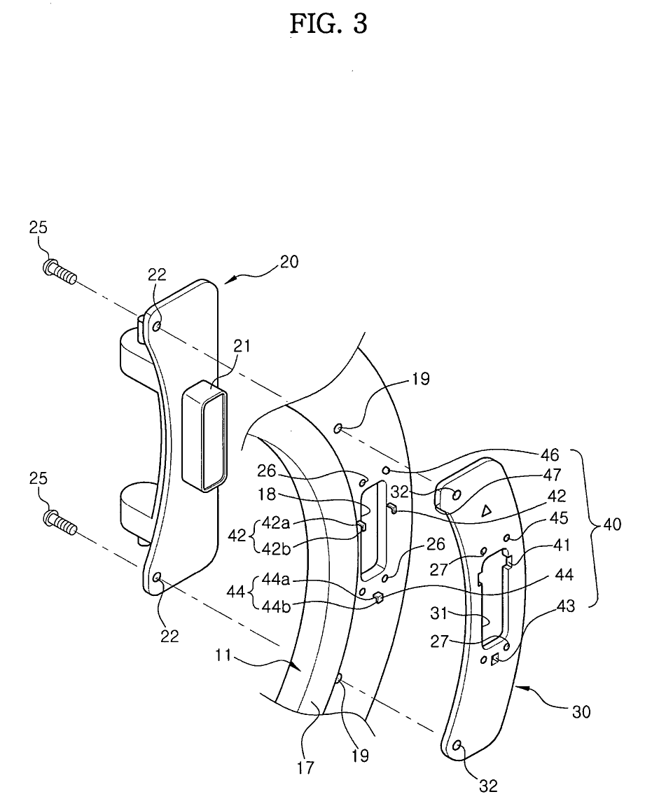

In FIG. 1, the hinge member 20 is installed on the left side of the opening 12 and the latch assembly 16 is installed in the right side of the opening 12. However, when a user wants to change the position of the hinge member 20 to the right side of the opening 12 according to circumstances, in which the drying machine is installed, or user's convenience, screws connecting the hinge member 20 to the hinge bracket 30 (with reference to FIGS. 3 to 5) and screws connecting the latch assembly 16 to the hinge bracket 30 are loosened, and then the hinge member 20 is connected to the hinge bracket 30 positioned at the right side of the opening 12. Thereby, it is possible to simply change the rotational direction of the door 13.

Hereinafter, with reference to FIGS. 3 to 5, the structure of the hinge bracket 30 and the structure of a portion of the front panel 11, on which the hinge bracket 30 is installed, will be described in detail.

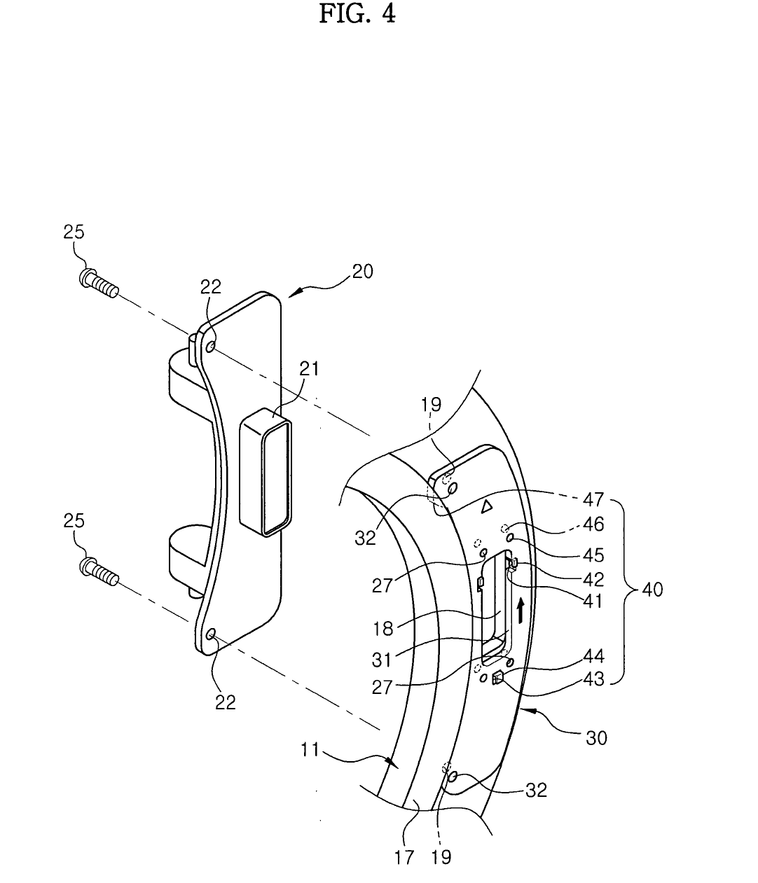

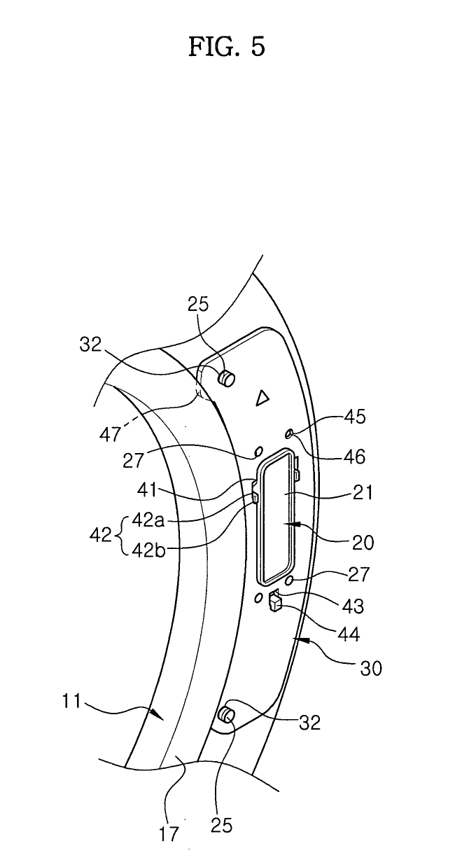

FIG. 3 illustrates the state in which the hinge bracket 30 and a hinge member 20 are separated from the front panel 11, FIG. 4 illustrates the state just before the hinge bracket 30 is pre-assembled with the rear surface of the front panel 11, and FIG. 5 illustrates the state in which the hinge member 20 is fixed to the hinge bracket 30 after the pre-assembling of the hinge bracket 30 with the rear surface of the front panel 11 is completed.

As shown in FIG. 3, a projecting part 21, which protrudes toward the front panel 11, and a plurality of screw holes 22 are formed on and in the rear surface of the hinge member 20. Through holes 31 and 18, into which the projecting part 21 of the hinge member 20 is inserted, are respectively formed through the central portion of the hinge bracket 30 and the front panel 11, on which the hinge bracket 30 is installed, and screw holes 32 and 19 corresponding to the screw holes 22 of the hinge member 20, into which screws 25 are inserted, are respectively formed through the hinge bracket 30 and the front panel 11, on which the hinge bracket 30 is installed.

A pre-assembly unit 40 for simply and rapidly fixing the hinge bracket 30 to the front panel 11 is formed on the rear surfaces of the hinge bracket 30 and the front panel 11.

The pre-assembly unit 40 includes a pair of first fixing holes 41, each of which has an approximately rectangular shape, extended from both sides of the through hole 31 of the hinge bracket 30, and a pair of first fixing protrusions 42, which is placed adjacent to both sides of the through hole 18 of the front panel 11 to be inserted into the first fixing holes 41.

Each of the first fixing protrusions 42 includes a vertical portion 42a protruding from the rear surface of the front panel 11 and having a length corresponding to the thickness of the hinge bracket 30, and a horizontal portion 42b extended from the vertical portion 42a in the longitudinal direction of the through hole 18 and having a length smaller than that of each of the first fixing holes 41.

Accordingly, when the first fixing protrusions 42 pass through the first fixing holes 41 and then the hinge bracket 30 is pushed so that the horizontal portions 42b of the first fixing protrusions 42 are inserted into the first fixing holes 41, the hinge bracket 30 is fixed to the front panel 11 (with reference to FIGS. 4 and 5).

The pre-assembly unit 40 further includes a rectangular-shaped second fixing hole 43 formed through the hinge bracket 30 below the fixing hole 31, and a second fixing protrusion 44 formed on the front panel 11 below the through hole 18 and inserted into the second fixing hole 43. In the same manner as the first fixing holes 41 and the first fixing protrusions 42, the second fixing hole 43 and the second fixing protrusion 44 serve to pre-assemble the hinge bracket 30 with the front panel 11.

In the same manner as the first fixing protrusions 42, the second fixing protrusion 44 includes a vertical portion 44a protruding from the rear surface of the front panel 11 and having a length corresponding to the thickness of the hinge bracket 30, and a horizontal portion 44b extended from the vertical portion 44a in the longitudinal direction of the through hole 18 and having a length smaller than that of the second fixing hole 43 and inserted into the second fixing hole 43, thereby stably fixing the position of the hinge bracket 30.

The pre-assembly unit 40 further includes a circular-shaped positioning hole 45 formed through the hinge bracket 30 above the through hole 31, and a hemispheric-shaped positioning protrusion 46 protruding from the rear surface of the front panel 11 and fitted into the positioning hole 45.

Accordingly, when the first and second fixing protrusions 42 and 44 are exactly inserted into the first and second fixing holes 41 and 43, the positioning hole 45 of the hinge bracket 30 is fitted to the positioning protrusion 46 of the front panel 11, thereby allowing the hinge bracket 30 to be firmly fixed to the front panel 11 without the requirement of screw-connecting or welding.

The pre-assembly unit 40 further includes a projecting part 47, which contacts the protrusion 17 protruding from the edge of the opening 12 of the front panel 11, for stably arranging the hinge bracket 11 at its regular position under the condition that the hinge bracket 30 is fixed to the front panel 11.

Screw holes 26 and 27 are formed through the front panel 11 and the hinge bracket 30, thereby allowing the latch assembly 16 (with reference to FIG. 2) disposed opposite to the hinge member 20 to be screw-connected and fixed to the hinge bracket 30.

Hereinafter, a process for simply attaching the hinge bracket 30 having the pre-assembly unit 40 to the rear surface of the front panel 11 without screw-connecting or welding will be described.

As shown in FIG. 4, the first fixing protrusions 42 and the second fixing protrusion 44 are respectively inserted into the first fixing holes 41 and the second fixing hole 43, the horizontal portions 42b of the first fixing protrusions 42 and the horizontal portion 44b of the second fixing protrusion 44 are respectively placed in the first fixing holes 41 and the second fixing hole 43, and the hinge bracket 30 is placed on the rear surface of the front panel 11 under the condition that the positions of the positioning hole 45 and the positioning protrusion 46 do not completely coincide with each other.

Thereafter, when the hinge bracket 30 is pushed in a direction of the arrow in FIG. 4, the positioning protrusion 46 is fitted into the positioning hole 45 simultaneously with the insertion of the horizontal parts 42b of the first fixing protrusions 42 and the horizontal part 44b of the second fixing protrusion 44 into the first fixing holes 41 and the second fixing hole 43, thereby preventing the hinge bracket 30 placed on the front panel 11 from moving back and forth, left and right, and up and down.

When the projecting part 47 protruding from the upper end of the hinge bracket 30 contacts the side surface of the protrusion 17 of the front panel 11, the projecting part 47 of the hinge bracket 30 is caught by the side surface of the protrusion 17 of the front panel 11, thereby stably attaching the hinge bracket 30 to the front panel 11 without movement.

When the projecting part 21 of the hinge member 20 passes through the through holes 18 and 31 of the front panel 11 and the hinge bracket 30 under the condition that the hinge bracket 30 is fixed to the front panel 11, the screw holes 22 of the hinge member 20 correspond to the screw holes 19 and 32 of the front panel 11 and the hinge bracket 30. Then, the screws 25 are inserted into the screw holes 22, 19, and 32, thereby fixing the hinge member 20 and the hinge bracket 30 to the front panel 11.

The above embodiment describes the pre-assembly unit 40 including the first and second fixing holes 41 and 43 and the first and second fixing protrusions 42 and 44. However, in case that the pre-assembly unit 40 includes one fixing hole and one fixing protrusion, the pre-assembly unit 40 can firmly attach the hinge bracket 30 to the front panel.

Although the hinge bracket and the hinge member are attached to the front panel of the drying machine in the above embodiment, the hinge bracket and the hinge member can be applied to any product having a door, such as a washing machine or a dishwasher.

As apparent from the above description, the present invention provides a drying machine, in which a hinge bracket for connecting a hinge member is simply and rapidly fixed to a front panel, thereby having a shortened assembly time.

Further, the drying machine of the present invention has a structure such that hinge brackets are respectively installed at both sides of the front panel so that the position of the hinge member is simply changed from one side of the front panel to the other side of the front panel, thereby rapidly changing the rotational direction of a door according to circumstances, in which the drying machine is installed, or user's convenience.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the following claims.

What is claimed is:

1. A drying machine comprising:
a door;
a front panel, on which the door is installed;
a hinge member for hinging the door to the front panel; and
a hinge bracket for connecting the hinge member to the front panel,
wherein a pre-assembly unit for positioning and fixing the hinge bracket on and to the front panel is formed on the hinge bracket and the front panel.

2. The drying machine according to claim 1,
wherein the pre-assembly unit includes a pair of first fixing holes formed through the hinge bracket, and a pair of first fixing protrusions protruded from the rear surface of the front panel and caught by the first fixing holes.

3. The drying machine according to claim 2, wherein:
through holes are respectively formed through the central area of the hinge bracket and the front panel so that a projecting part protruding from the rear surface of the hinge member is inserted into the through holes; and
the first fixing holes, each of which has a designated size, are extended from both sides of the through hole of the hinge bracket.

4. The drying machine according to claim 3,
wherein each of the first fixing protrusions includes a vertical portion protruding from the rear surface of the front panel and having a length corresponding to the thickness of the hinge bracket, and a horizontal portion extended horizontally from the vertical portion and inserted into the corresponding one of the first fixing holes.

5. The drying machine according to claim 1,
wherein the pre-assembly unit includes a second fixing hole formed through the hinge bracket, and a second fixing protrusion protruding from the rear surface of the front panel and caught by the second fixing hole.

6. The drying machine according to claim 5,
wherein the second fixing protrusion includes a vertical portion protruding from the rear surface of the front panel and extended to have a length corresponding to the thickness of the hinge bracket, and a horizontal portion extended horizontally from the vertical portion to have a length smaller than that of the second fixing hole and inserted into the second fixing hole.

7. The drying machine according to claim 1,
wherein the pre-assembly unit includes a positioning hole formed through the hinge bracket, and a positioning protrusion protruding from the rear surface of the front panel and fitted into the positioning hole.

8. The drying machine according to claim 1,
wherein the pre-assembly unit includes a projecting part protruding from one side end of the hinge bracket;
and wherein said front panel includes a protrusion which protrudes from the edge of an opening formed through a central portion of the front panel and said projection part is caught by a side surface of said protrusion to fix it at a designated position.

9. A drying machine comprising:
a front panel having an opening formed through the central portion thereof;
a door installed on the front panel for opening and closing the opening;
a hinge member for hinging the door to the front panel;
a pair of hinge brackets for selectively connecting the hinge member to one of opposite sides of the opening of the front panel; and
a pre-assembly unit formed on rear surfaces of the hinge bracket and the front panel for positioning and fixing the hinge bracket on and to the front panel.

10. The drying machine according to claim 9,
wherein the pre-assembly unit includes at least one fixing hole formed through the hinge bracket, at least one fixing protrusion protruded from the rear surface of the front panel and caught by the fixing hole, a positioning hole formed through the hinge bracket, and a positioning protrusion protruding from the rear surface of the front panel and fitted into the positioning hole.

11. The drying machine according to claim 10, wherein:
the fixing hole has a size greater than that of the fixing protrusion; and
the fixing protrusion includes a vertical portion vertically protruding from the rear surface of the front panel and having a length corresponding to the thickness of the hinge bracket, and a horizontal portion extended horizontally from the vertical portion, so that the vertical portion passes through the fixing hole and the horizontal portion is inserted into the fixing hole, and simultaneously the positioning hole is fitted to the positioning protrusion, thereby pre-assembling the hinge bracket with the front panel without movement.

12. The drying machine according to claim 10,
wherein the pre-assembly unit further includes a projecting part protruding from one side end of the hinge bracket and caught by the side surface of a protrusion, protruding from the edge of an opening formed through the central portion of the front panel, to be fixed to a designated position.

13. The drying machine according to claim 2,
wherein the pre-assembly unit includes a second fixing hole formed through the hinge bracket, and a second fixing protrusion protruding from the rear surface of the front panel and caught by the second fixing hole.

14. The drying machine according to claim 13,
wherein the second fixing protrusion includes a vertical portion protruding from the rear surface of the front panel and extended to have a length corresponding to the thickness of the hinge bracket, and a horizontal portion extended horizontally from the vertical portion to have a length smaller than that of the second fixing hole and inserted into the second fixing hole.
